(19) United States
(12) Patent Application Publication
(10) Pub. No.: US 2006/0044233 A1
(43) Pub. Date: Mar. 2, 2006

(54) Frame memory driving method and display using the same

(76) Inventors: Kyoung Soo Lee, Suwon (KR); Jae Sung Lee, Seoul (KR)

Correspondence Address: CHRISTIE, PARKER & HALE, LLP, PO BOX 7068, PASADENA, CA, 91109-7068, US

(21) Appl. No.: 11/211,403

(22) Filed: Aug. 24, 2005

(30) Foreign Application Priority Data
Aug. 30, 2004 (KR) 2004-68402

(51) Int. Cl. G09G 3/30

(52) U.S. Cl. 345/76

(57) ABSTRACT

A frame memory control method that reads out video data from a frame memory at a reading speed twice as fast as a writing speed, and a sequential driving type display using the same. The method includes: storing (or writing in) video data corresponding to one frame in the frame memory in sequence; reading out the video data of a first group including one of the video data selected from odd numbered video data and even numbered video data stored in the frame memory at or after a half point of a period for storing the video data corresponding to one frame; reading out the video data of a second group including another one of the video data selected from the odd numbered video data and the even numbered video stored in the frame memory after reading out the video data of the first group; and transmitting the video data of the first group and the video data of the second group to a transistor to drive at least two light emitting devices in sequence.

### CROSS-REFERENCE TO RELATED APPLICATIONS

This application claims priority to and the benefit of Korean Patent Application No. 10-2004-0068402, filed on Aug. 30, 2004, in the Korean Intellectual Property Office, the entire content of which is incorporated herein by reference.

### BACKGROUND

1. Field of the Invention

The present invention relates to a frame memory driving method and a display using the same, and more particularly, to a frame memory driving method for reading out video data from a frame memory at a reading speed that is faster than a writing speed, and a sequential driving type display using the same.

2. Discussion of Related Art

In general, a display is refers to as a device that supplies input video data to a pixel portion through a driver and displays a predetermined image on the pixel portion. In the display, the video data is displayed on the pixel portion by a unit of one frame. For example, to display a still picture, an image of the video data corresponding to one frame is maintained for a predetermined period. On the other hand, to display a moving picture, several images of the video data corresponding to one frame are consecutively displayed one after another for a period of time (e.g., one second). The images appear to humans as the moving picture.

The display repeatedly writes and reads the video data in a memory to display an image on a screen thereof. Because of this, examples of the memory that can be used with the display include a video memory, a frame memory, etc. The video memory stores a large amount of video data, makes a three-dimensional graphic process or the like possible, and is embedded in a video card or the like. On the other hand, the frame memory stores a small amount of video data as a unit of frame, and is connected to a controller or a driving circuit provided in the display.

FIG. 1 illustrates a configuration of a conventional display.

Referring to FIG. 1, the display includes a pixel portion 120 having a plurality of pixels 110, a scan driver 130, a data driver 140, a controller 150, and a frame memory 160.

The pixel portion 120 includes the plurality of pixels 110 formed in intersection areas of a plurality of scan lines S1, S2, S3, . . . , Sn, and a plurality of data lines D1, D2, D3, . . . , Dm. Each pixel 110 is activated by a scan signal transmitted through the scan lines S1, S2, S3, . . . , Sn, and emits light corresponding to a data signal transmitted through the data lines D1, D2, D3, . . . , Dm.

The scan driver 130 generates the scan signal in response to a scan control signal supplied from the controller 150, and supplies the respective scan signals to the scan lines S1 through Sn in sequence. Here, the scan control signal includes a clock signal, a reset signal, a vertical synchronization signal, etc.

The data driver 140 generates the data signal by converting video data in response to a data control signal supplied from the controller 150, and supplies the data signal to the respective data lines D1 through Dm in sequence. Here, the data control signal includes a clock signal, a reset signal, a horizontal synchronization signal, etc.

The controller 150 generates the one or more control signals such as clock signals, reset signals, vertical synchronization signals, horizontal synchronization signals, etc., and controls the scan driver 130 and the data driver 140 based on the control signals. For this, the controller 150 includes a control signal generator (not shown) and a frame memory controller (not shown). Further, the controller 150 controls the frame memory 160 to store the video data inputted from an external host (not shown), and reads out the video data from the frame memory 160, thereby transmitting the video data to the data driver 140.

The frame memory 160 stores the video data in response to a control signal of the controller 150, and outputs the video data. Here, the frame memory 160 generally has a capacity to store the video data corresponding to two or more frames. The frame memory 160 operates as follows.

FIG. 2 illustrates the frame memory 160 of FIG. 1. FIG. 3 shows timing operations of the frame memory 160 illustrated in FIG. 2.

Referring to FIG. 2, the frame memory 160 includes a first frame memory 162, and a second frame memory 164. The first frame memory 162 and the second frame memory 164 alternately store and alternately output the video data by a unit of frame, in which the video data is sequentially inputted corresponding to a control signal CTRL of the controller.

In more detail, as shown in FIG. 3, the frame memory 160 operates in response to a control signal Vsync of the controller, so that the (N−1)^{th} frame data previously stored in the second frame memory 164 is read out while the N^{th} frame data is written in the first frame memory 162. Then, the N^{th} frame data stored in the first frame memory 162 is read out while the (N+1)^{th} frame data is written in the second frame memory 164. Then, the (N+1)^{th} frame data stored in the second frame memory 164 is read out while the (N+2)^{th} frame data is written in the first frame memory 162. Then, the (N+2)^{th} frame data stored in the first frame memory 162 is read out while the (N+3)^{th} frame data is written in the second frame memory 164.

Thus, the frame memory 160 employs at least two frame memories 162, 164 or a frame memory (not shown) capable of storing the video data corresponding to at least two frames to thereby alternately store and alternately output the video data. In the frame memory 160, write frequency and read frequency are equal to each other.

However, when a driving circuit of a display is integrated as a chip and mounted on the display like a driver integrated chip (IC) used in the display, the frame memory should have a predetermine size to store the frame data corresponding to two or more frames. Because of this, it is difficult to decrease the size of the frame memory. Thus, there is a limit as on how much the size of the driver IC of the display can be decreased.

As such, in the conventional display, there is a limit on how much the size of a chip-type driving circuit can be decreased because of the size of the frame memory embedded in the driving circuit. Thus, it is difficult to design a wiring line such as a power line, a control line, or the like for the conventional display, and a freedom of design is restricted.

### SUMMARY OF THE INVENTION

Accordingly, an embodiment of the present invention provides a frame memory control method, in which a frame memory having a capacity corresponding to one frame is applicable to a sequential driving type display.

An embodiment of the present invention provides a sequential driving type display using the foregoing frame memory control method.

One embodiment of the present invention provides a method of controlling a frame memory. The method includes: (a) storing (or writing in) video data corresponding to one frame in the frame memory in sequence; (b) reading out the video data of a first group including one of the video data selected from odd numbered video data and even numbered video data stored in the frame memory at or after a half point of a period for storing the video data corresponding to the one frame; (c) reading out the video data of a second group including another one of the video data selected from the odd numbered video data and the even numbered video data stored in the frame memory after reading out the video data of the first group; and (d) transmitting the video data of the first group and the video data of the second group to a transistor to drive at least two light emitting devices in sequence.

According to one embodiment of the invention, the storing the video data in sequence includes storing (or writing in) the video data corresponding to a next frame in sequence at or after a starting point of a period for reading out the video data corresponding to the second group.

According to one embodiment of the invention, the storing the video data in sequence includes storing (or writing in) the video data in sequence with a writing dummy period during which the video data are not stored. Further, the reading out the video data of the first group and the reading out the video data of the second group are in sequence and comprise reading out the video data of the first group and reading out the video data of the second group in sequence with first and second reading dummy periods during which the video data are not read.

One embodiment of the present invention provides a display including: a pixel portion having a plurality of pixels electrically connected to a plurality of scan lines, a plurality of emission control lines, and a plurality of data lines, at least one of the pixels having a first transistor adapted to drive first and second light emitting devices in sequence; a driver adapted to supply a scan signal, a emission control signal, and a data signal to at least one of the scan lines, at least one of the emission control lines, and at least one of the data lines, respectively; a frame memory adapted to store video data; and a controller adapted to control the driver and the frame memory, wherein the controller stores (or writes in) the video data corresponding to one frame in the frame memory in sequence, reads out the video data of a first group including one of the video data selected from odd numbered video data and even numbered video data stored in the frame memory at or after a half point of a period for storing the video data corresponding to the one frame, transmits the read video data of the first group to the driver, reads out the video data of a second group including another one of the video data selected from the odd numbered video data and the even numbered video data stored in the frame memory after reading out the video data of the first group, and transmits the read video data of the second group to the driver.

According to one embodiment of the invention, first video data corresponding to the video data of the first group and second video data corresponding to the video data of the second group are transmitted to a gate of the first transistor to drive the first and second light emitting devices in sequence.

According to one embodiment of the invention, the controller stores (or writes in) the video data corresponding to a next frame in sequence at or after a starting point of a period for reading out the video data corresponding to the second group.

According to one embodiment of the invention, the controller stores (or writes in) the video data in sequence with a writing dummy period during which the video data are not stored. Further, the controller reads out the video data of the first group and the video data of the second group in sequence and with first and second reading dummy periods during which the video data are not read.

### BRIEF DESCRIPTION OF THE DRAWINGS

The accompanying drawings, together with the specification, illustrate exemplary embodiments of the present invention, and, together with the description, serve to explain the principles of the invention.

FIG. 1 illustrates a configuration of a conventional display;

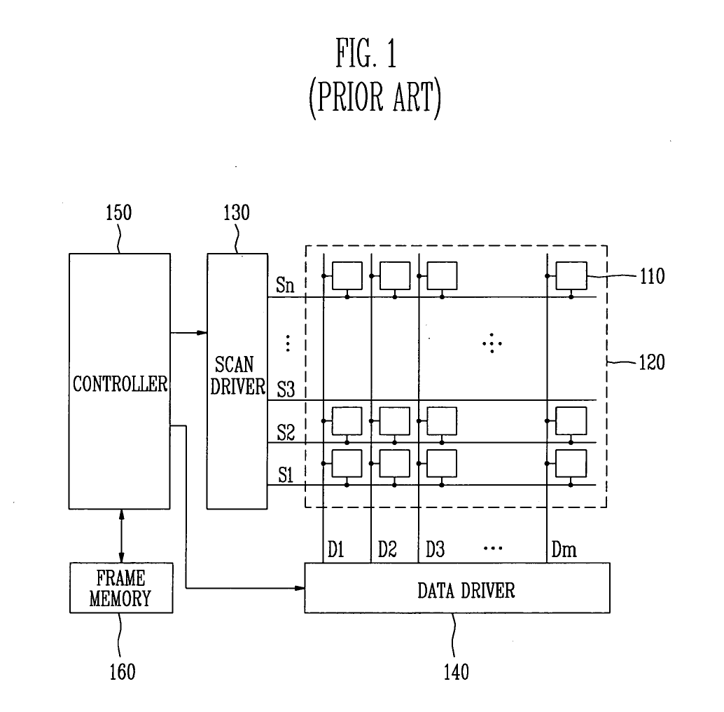

FIG. 2 illustrates a frame memory of the conventional display of FIG. 1;

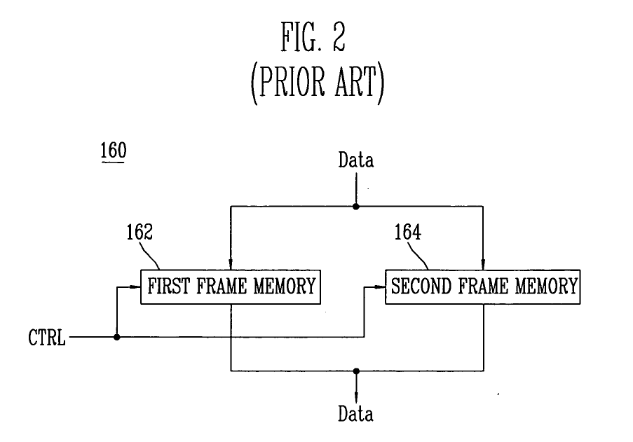

FIG. 3 shows timing operations of the frame memory illustrated in FIG. 2;

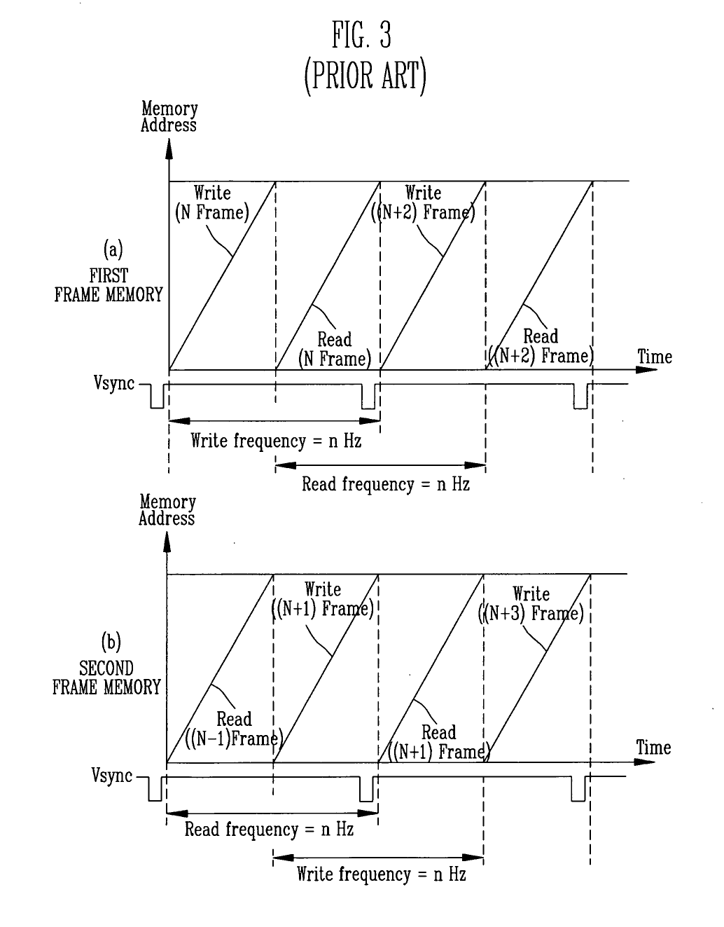

FIG. 4 illustrates a configuration of a light emitting display according to an embodiment of the present invention;

FIG. 5 illustrates a frame memory of the light emitting display of FIG. 4 according to an embodiment of the present invention;

FIG. 6 shows timing operations of the frame memory of FIG. 5 according to an embodiment of the present invention;

FIG. 7 is a circuit diagram of a pixel circuit provided in a light emitting display according to an embodiment of the present invention;

FIG. 8 shows timing of signals for driving the light emitting display including the pixel circuit illustrated in FIG. 7; and

FIG. 9 illustrates configuration of a light emitting display according to another embodiment of the present invention.

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification, as they are not essential to a complete understanding of the invention. Like reference numerals designate like elements.

In the following descriptions, when some part is described to be connected to some other part, it includes not only the case where they are connected directly but also the case where they are electrically connected by having some other element therebetween.

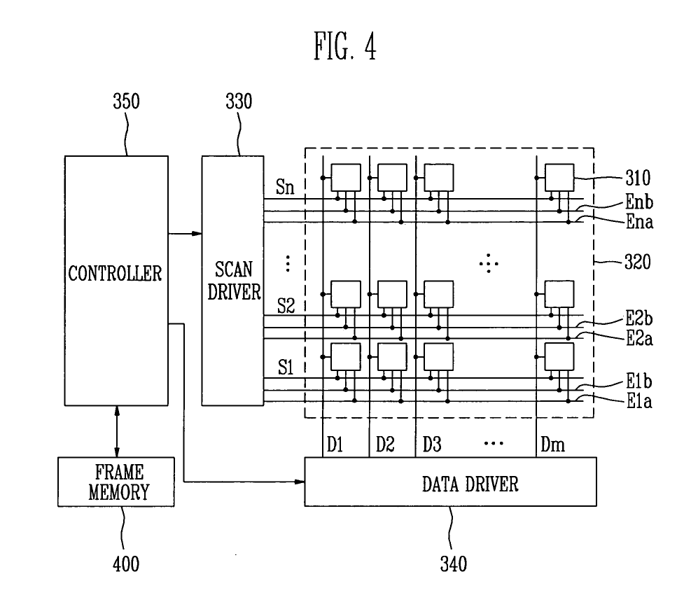

FIG. 4 illustrates a configuration of a light emitting display according to an embodiment of the present invention..

Referring to FIG. 4, the display according to the embodiment of the present invention includes a pixel portion 320, a scan driver 330, a data driver 340, a controller 350, and a frame memory 400 to thereby display an image on the pixel portion 320 corresponding to input data.

The pixel portion 320 includes a plurality of pixels 310 formed in intersection areas of a plurality of scan lines S1, S2, S3, . . . , Sn, and a plurality of data lines D1, D2, D3, . . . , Dm. Each pixel 310 is activated by a scan signal transmitted through the scan lines S1, S2, S3, . . . , Sn, and emits light corresponding to a data signal transmitted through the data lines D1, D2, D3, . . . , Dm.

The scan driver 330 generates the scan signal in response to a control signal supplied from the controller 350, and supplies the respective scan signals to the scan lines S1 through Sn in sequence. Here, the control signal includes a clock signal, a reset signal, a vertical synchronization signal, etc.

Further, the scan driver 330 generates an emission control signal in response to the control signal supplied from the controller 350, and supplies the emission control signals to emission control lines E1a, E1b, E2a, E2b, . . . , Ena, Enb in sequence.

The data driver 340 generates the data signal by converting video data in response to a data control signal supplied from the controller 350, and supplies the data signal to the respective data lines D1 through Dm in sequence. Here, the data control signal includes a clock signal, a reset signal, a horizontal synchronization signal, etc. Further, the data signal has a predetermined voltage level or a predetermined current level.

The controller 350 generates the one or more control signals such as clock signals, reset signals, vertical control signals, horizontal control signals, etc., and controls the scan driver 330 and the data driver on the basis of the control signals. For this, the controller 350 includes a control signal generator (not shown) and a frame memory controller (not shown).

Further, the controller 350 controls the frame memory 400 to store the video data inputted from an external host (not shown), and reads out the video data from the frame memory 400, thereby transmitting the video data to the data driver 340.

In more detail, the controller 350 controls the frame memory to sequentially store video data corresponding to one frame, and sequentially reads out the video data of a first group including one of the video data selected from the (2n−1)^{th} (odd numbered) video data and the 2n^{th} (even numbered) video data from the frame memory 400 at a point in time equal to or after T/2 in a period T for substantially storing the video data, where n is a natural number. After reading out the video data of the first group, the controller 350 sequentially reads out the video data of a second group including the other one of the video data selected from the (2n−1)^{th} video data and the 2n^{th} video data from the frame memory 400.

Here, the controller 350 may include various suitable controlling units that are connected to the frame memory 400 and control the frame memory 400. For example, the controller may be realized by a central processing unit (CPU) or a microprocessor unit (MPU), which is provided in a portable terminal (e.g., a mobile phone) or the like having the display of FIG. 4.

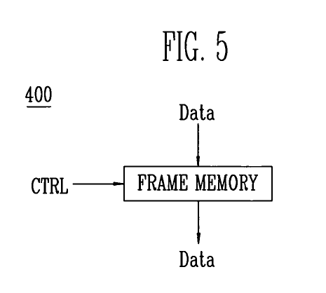

As shown in FIG. 5, the frame memory 400 sequentially stores and sequentially outputs the video data based on control (e.g., via a control signal CTRL) of the controller 350. Particularly, the frame memory 400 is realized by one memory provided in the driving circuit of the display and having a capacity (e.g., a storing capacity) corresponding to one frame. The frame memory 400 can be formed as a separate device or integrally formed in the controller 350. Further, the frame memory 400 can be provided in an integrated circuit with the data driver 340 and the controller 350. Hereinbelow, the frame memory 400 will be described in more detail.

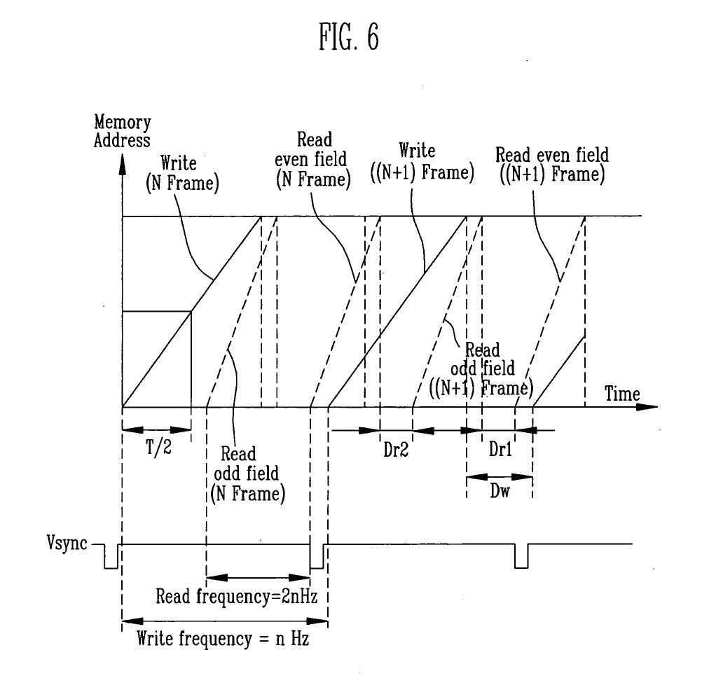

FIG. 6 shows timing operations of the frame memory 400 provided in the light emitting display according to an embodiment of the present invention.

Referring to FIG. 6, an N^{th} frame data inputted in response to a control signal Vsync of the controller 350 is sequentially written in the frame memory 400 during a period of T. At a point in time equal to or after T/2, the frame memory 400 starts sequentially reading out data of the N^{th} frame data stored for a previous half period T/2 while storing the other data for a later half period T/2. At the point in time equal to or after T/2, the frame memory 400 outputs (or reads out) first group video data (or odd field of the N^{th} frame data) including the (2n−1)^{th} video data (or the 2n^{th} video data), which is stored in the frame memory 400 during the previous half period T/2. After outputting the first group video data, the frame memory 400 outputs (or reads out) second group video data including the 2n^{th} video data (or the (2n−1)^{th} video data). Similarly, the (N+1)^{th} video data is sequentially stored (written in) and outputted (or read out) like the N^{th} frame data.

In this embodiment, the frame memory 400 is controlled to have a reading frequency (speed) twice as fast as a writing frequency (speed). Therefore, the period during which the frame memory 400 writes the video data corresponding to one frame (e.g., the N^{th} frame data) is equal to the period during which the frame memory 400 reads out the video data corresponding to one frame (e.g., the (2n−1)^{th} video data and the 2n^{th} video data).

Further, the period, during which the frame memory 400 sequentially stores the video data therein, includes a writing dummy period Dw during which the frame memory 400 substantially does not store the video data therein. Here, the writing dummy period Dw is provided to prevent the video data from being written in the same field and at the same time when the data are being read from the same field.

In the foregoing embodiment, a first reading dummy period Dr1 and a second reading dummy period Dr2, during which the video data are not read, are also provided to correspond to the writing dummy period Dw when the frame memory 400 sequentially reads out the first and second group video data, respectively. In one embodiment, the writing dummy period Dw is equal to a sum of the first reading dummy period Dr1 and the second reading dummy period Dr2.

Thus, according to an embodiment of the present invention, only one frame memory 400 having the capacity to store the video data corresponding to one frame is used for storing and outputting the video data. Further, according to an embodiment of the present invention, the video data stored in the frame memory 400 is divided into two and then outputted, so that it can be used in a sequential driving type display having a pixel circuit including at least one driving transistor connected with two light emitting devices.

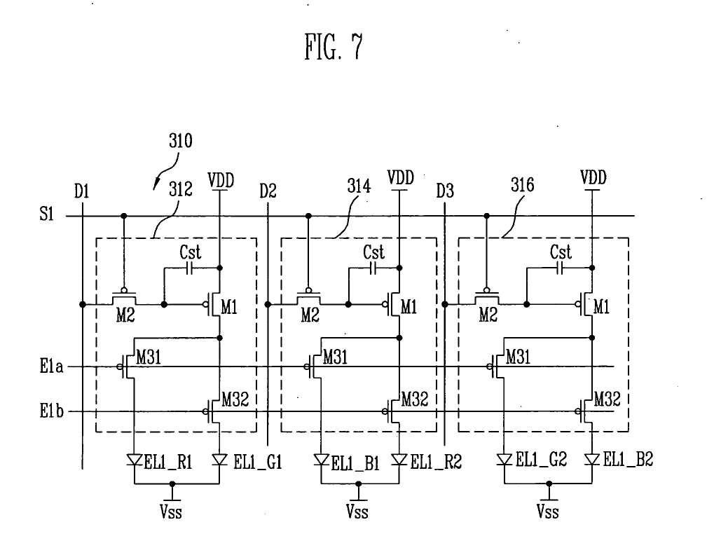

FIG. 7 is a circuit diagram of a pixel circuit provided in a light emitting display (e.g., the display of FIGS. 4, 5, and/or 6) according to an embodiment of the present invention. In FIG. 7, transistors provided in the pixel circuit are formed by p-channel transistors.

Referring to FIG. 7, a pixel circuit 312, 314, 316 applicable to the display according to the embodiment of the present invention is a sequential driving circuit in which first and second light emitting devices EL1_R1, EL1_G1; EL1_B1, EL_R2; EL1_G2, EL1_B2 are sequentially driven by first and second emission control signals E1a, E1b and first and second data signals transmitted through data lines D1, D2, D3 for a horizontal period during which one scan signal S1 is applied. Hereinafter, the pixel circuit 312 provided in the pixel 310 formed in a region defined by the predetermined scan line S1 and the predetermined data line D1 will be exemplarily described. Further, the pixel 310 includes the pixel circuit 312 and the first and second light emitting devices EL1_R1, EL1_G1.

The pixel circuit 312 includes a first transistor Ml, a second transistor M2, a third transistor M31 to limit an emission period of the first light emitting device EL1_R1, and a fourth transistor M32 to limit an emission period of the second light emitting device EL1_G1. Here, the first light emitting device EL1_R1 indicates a red light emitting device, and the second light emitting device EL1_G1 indicates a green light emitting device. Further, the light emitting device EL1_R1, EL1_G1 includes an organic light emitting diode having an organic thin film using an organic material as an emission layer, and an anode and a cathode contacting opposite surfaces of the organic thin film. Alternatively, the first and second light emitting devices EL1_R1, EL1_G1 may include a pair of light emitting devices to represent the same color, or a pair of light emitting devices to represent different colors of red, green and blue as well as the foregoing configuration.

In more detail, the first transistor Ml includes a source connected to a first power line for supplying a first power voltage VDD, a drain commonly connected to each source of the third transistor M31 and the fourth transistor M32, and a gate connected to a drain of the second transistor M2.

Further, the first transistor M1 operates as a predetermined current source depending on a first data voltage applied between the gate and the source thereof for a predetermined period of one frame, and functions as a driving transistor, thereby supplying the predetermined current to the first light emitting device EL1_R1 through the third transistor M31.

Also, the first transistor M1 operates as a predetermined current source depending on a second data voltage applied between the gate and source thereof for another (or the other) period of the one frame, and functions as a driving transistor, thereby supplying the predetermined current to the second light emitting device EL1_G1 through the fourth transistor M32.

The second transistor M2 includes a source connected to the data line D1, a drain connected to a first electrode of a capacitor Cst, and a gate connected to the scan line S1.

Further, the second transistor M2 is turned on when a scan signal having an enable level or a low level is transmitted to the scan line S1, and supplies the data voltage from the data line D1 to the gate of the first transistor M1 and the first electrode of the capacitor Cst. For example, the second transistor M2 responds twice to the scan signal having the enable level for the period corresponding to one frame, and sequentially supplies the first and second data voltages from the data line D1 to the gate of the firs transistor M1.

The third transistor M31 includes the source connected to the drain of the first transistor M1, a drain connected to an anode of the first light emitting device EL1_R1, and a gate connected to the first emission control line E1a. Here, the first emission control line E1a is connected to a scan driver (e.g., the scan driver 330 of FIG. 4), and supplies a first emission control signal to the gate of the third transistor M31, thereby controlling the emission period of the first light emitting device EL1_R1.

Further, the third transistor M31 maintains or interrupts electrical connection between the first transistor M31 and the first light emitting device EL1_R1 for a predetermined period in response to the first emission control signal transmitted through the first emission control line E1a. Also, the third transistor M31 selectively supplies the current from the first transistor M1 to the first light emitting device EL1_R1. Here, a cathode of the first light emitting device EL1_R1 is connected to a second power line for supplying a second power voltage VSS which is lower than the first power voltage VDD.

The fourth transistor M32 includes the source connected to the drain of the first transistor M1, a drain connected to an anode of the second light emitting device EL1_G1, and a gate connected to the second emission control line E1b. Here, the second emission control line E1b supplies a second emission control signal to the gate of the fourth transistor M32, thereby controlling the emission period of the second light emitting device EL1_G1. Further, the second emission control signal has an enable level or a low level, which is not overlapped with the first emission control signal for one horizontal period.

Further, the fourth transistor M32 maintains or interrupts electrical connection between the fourth transistor M32 and the second light emitting device EL1_G1 in response to the second emission control signal transmitted through the second emission control line E1b. Also, the fourth transistor M32 selectively supplies the current from the first transistor M1 to the second light emitting device EL1_G1. Here, a cathode of the second light emitting device EL1_G1 is commonly connected with the first light emitting device EL1_R1 to the second power line for supplying the second power voltage VSS.

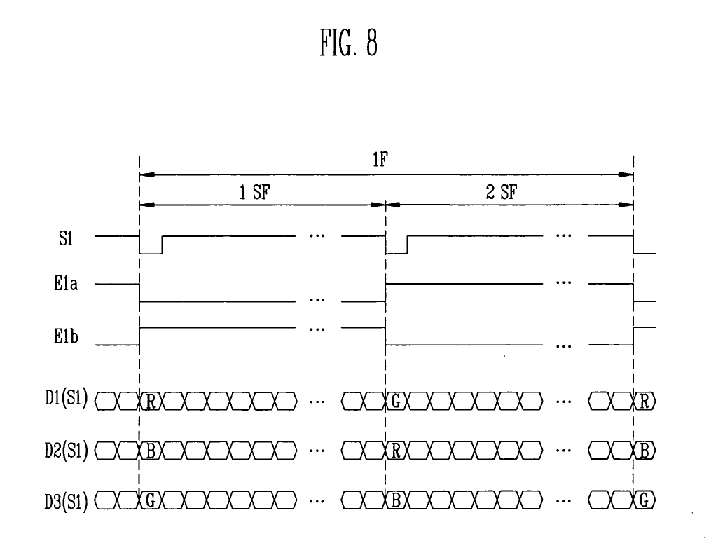

FIG. 8 shows timing of signals for driving the light emitting display including the pixel circuit illustrated in FIG. 7. In this embodiment, one field 1F includes first and second sub-fields 1SF and 2SF. The first and second sub-fields 1SF and 2SF of the embodiment have the same period. For the sake of convenience, the timing for driving some certain pixel circuits electrically connected to a predetermined scan line S1 for one field period will be exemplarily described hereinbelow.

Referring to FIGS. 7 and 8, the pixel circuit applicable to the display according to an embodiment of the present invention sequentially controls the first and second light emitting devices EL1_R1, EL1_G1; EL1_B1, EL1_R2; EL1_G2, EL1_B2 for the first and second sub-fields 1SF, 2SF of one horizontal period or one field 1F that indicates time for activating one row line.

For the first sub-field 1SF, when the scan signal having a low level is transmitted to the scan line S1, the second transistor M2 is turned on. At this time, the first data voltage applied to the data line D1, D2, D3 is supplied to the gate of the first transistor M1 provided in the pixel circuit 312, 314, 316. Further, the capacitor Cst is charged with voltage corresponding the first data voltage. Also, the first transistor M1 functions as a predetermined current source according to the voltage applied between the gate and the source. Further, when the first emission control signal having a low level is transmitted to the first emission control line E1a, the third transistor M31 is turned on, and thus the current is supplied from the first transistor M1 to the first light emitting device EL1_R1, EL1_B1, EL1_G2. At this time, the second emission control signal having a high level is transmitted to the second emission control line E1b, and thus the fourth transistor M32 is turned off, thereby interrupting the current flowing in the second light emitting device EL1_G1, EL1_R2, EL1_B2.

For the second sub-field 2SF, when the scan signal having a low level is transmitted to the scan line S1, the second transistor M2 is turned on. At this time, the second data voltage applied to the data line D1, D2, D3 is supplied to the gate of the first transistor M1 provided in the pixel circuit 312, 314, 316. Further, the capacitor Cst is charged with voltage corresponding to the second data voltage. Also, the first transistor M1 functions as a predetermined current source according to the voltage applied between the gate and the source. Further, when the second emission control signal having a low level is transmitted to the second emission control line E1b, the fourth transistor M32 is turned on, and thus the current is supplied from the first transistor M1 to the second light emitting device EL1_G1, EL1_R2, EL1_B2. At this time, the first emission control signal having a high level is transmitted to the first emission control line E1a, and thus the third transistor M3 is turned off, thereby interrupting the current flowing in the first light emitting device EL1_R1, EL1_B1, EL1_G2.

Thus, in the frame memory control method according to an embodiment of the present invention, a memory having a capacity to store data corresponding to one frame is provided in a driver integrated chip (IC), and used for a sequential driving type display.

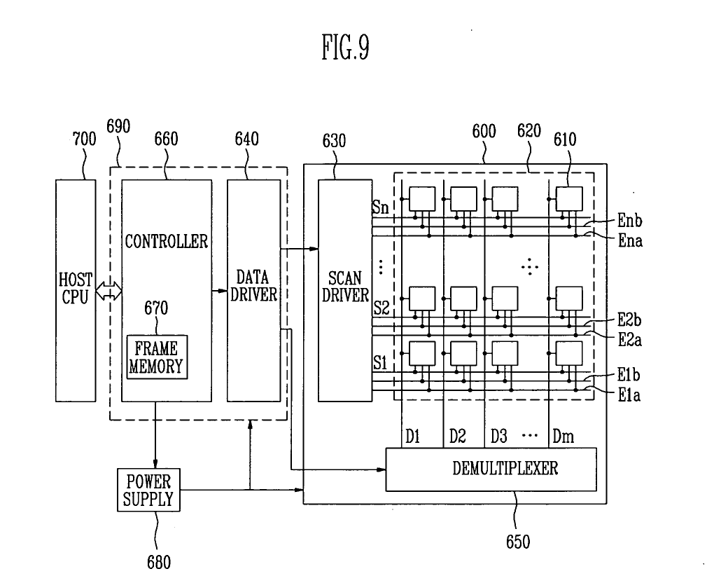

FIG. 9 illustrates configuration of a light emitting display according to another embodiment of the present invention.

Referring FIG. 9, a display according to another embodiment of the present invention includes a pixel portion 620, a scan driver 630, a data driver 640, a controller 660, a frame memory 670, and a power supply 680 to thereby display an image on the pixel portion 620 corresponding to input data.

The pixel portion 620 includes a plurality of pixels 610 formed in intersection areas of a plurality of scan lines S1, S2, S3, . . . , Sn, and a plurality of data lines D1, D2, D3, . . . , Dm. Each pixel 610 is activated by a scan signal transmitted through the scan lines S1, S2, S3, . . . , Sn, and emits light corresponding to a data signal transmitted through the data lines D1, D2, D3, . . . , Dm.

The pixel portion 620 includes a plurality of emission control lines E1a, E1b, E2a, E2b, . . . , Ena, Enb to transmit an emission control signal to each pixel 610. Here, two emission control lines E1a, E1b, E2a, E2b, . . . , Ena, Enb form a pair. Alternatively, the emission control lines E1a, E1b, E2a, E2b, . . . , Ena, Enb can be used individually (or independently) when the transistors controlled by the emission control signal are different in a channel type, that is, when one transistor is a p-channel type transistor and another transistor is an n-channel type transistor, respectively.

The scan driver 630 generates the scan signal in response to a control signal supplied from the controller 660, and supplies the respective scan signals to the scan lines S1 through Sn in sequence. Here, the control signal includes a clock signal, a reset signal, a vertical synchronization signal, etc.

Further, the scan driver 630 generates an emission control signal in response to the control signal supplied from the controller 660, and supplies first and second emission control signals to the pixel 610 connected to each pair of emission control lines E1a, E1b, E2a, E2b, . . . , Ena, Enb in sequence.

The data driver 640 generates the data signal by converting video data in response to a data control signal supplied from the controller 660, and supplies the data signal to the respective data lines D1 through Dm via a demultiplexer 650 in sequence. Here, the control signal includes a clock signal, a reset signal, a horizontal synchronization signal, etc. Further, the data signal may include a data voltage or a data current. For example, when the data driver 640 has 48 channel outputs, the demultiplexer 650 can convert 48 channel inputs from the data driver 640 into 176×3 channel outputs and supply them to the respective data lines D1, D2, D3, . . . , Dm of the pixel portion 620.

Meanwhile, the pixel portion 620, the scan driver 630, and the demultiplexer 650 are formed on the same substrate 600.

The controller 660 generates the one or more control signals including start signals such as start pulses or the like, clock signals, reset signals, vertical control signals, horizontal control signals, etc. Further, the controller 660 controls the scan driver 630, the data driver 640, and the demultiplexer 650. Also the controller receives video data from an external host 700, controls the internal frame memory 670 to store the video data, reads out the stored video data from the frame memory 670, and transmits the read video data to the data driver 640.

In more detail, the controller 660 controls the frame memory to sequentially store video data corresponding to one frame, and sequentially reads out the video data of a first group including one of the video data selected from the (2n−1)^{th} video data and the 2n^{th} video data from the frame memory 670 at a point in time equal to or after T/2 in a period T for substantially storing the video data, where n is a natural number. After reading out the video data of the first group, the controller 660 sequentially reads out the video data of a second group including the other one of the video data selected from the (2n−1)^{th} video data and the 2n^{th} video data from the frame memory 670. The first and second read video data is sequentially transmitted to the gate of the transistor to sequentially drive two light emitting devices provided in each pixel 610 of the sequential driving type pixel portion 620.

In the foregoing embodiment, the data driver 640 and the controller 650 are formed on one integrated circuit or the driver IC 690. In this case, the driver IC 690 can be fabricated as a chip or the like on a tape carrier package (TCP), a flexible printed circuit (FPC), or a tape automatic bonding (TAB) which is attached to and electrically connected to the substrate 600.

The frame memory 670 has a capacity corresponding to one frame, and is embedded in the controller 660. The frame memory 670 includes a writable and readable static random access memory (SRAM) which can maintain data bits as long as power is supplied. Alternatively, the frame memory 670 may include various other suitable memories that can function like the SRAM.

The power supply 680 respectively supplies a predetermined power to the pixel portion 620, the scan driver 630, the demultiplexer 640, and the driver IC 690 including the data driver 640 and the controller 660, which are formed on the substrate 600, in response to the control signal of the controller 670.

Thus, in the display according to the embodiment of FIG. 9, the frame memory 670 provided in the controller 660 of the driver IC 690 is realized by a memory having a capacity corresponding to one frame, so that the size and the occupying space of the driver IC 690 are decreased as compared with a conventional display. Therefore, a freedom of design of the display including the driver IC 690 is improved, and a fabrication cost is decreased.

In the foregoing embodiments, the frame memory control method can be applied to the display using a dual scan method, a interlaced scan method, or other scan methods, as well as the display using a signal scan method or a progressive scan method.

In the foregoing embodiments, a pixel circuit is a voltage programming type pixel circuit having a switching transistor, and a driving transistor. Alternatively, a pixel circuit may include a voltage programming type pixel circuit including a transistor to compensate a threshold voltage of a driving transistor or to compensate a voltage drop, a switching transistor, and a driving transistor. Further, a pixel circuit according to an embodiment of the present invention may include a current programming type pixel circuit for supplying a data current as a data signal and/or a voltage programming type pixel circuit.

In the foregoing embodiment, a transistor provided in a pixel circuit includes a source, a drain and a gate. Alternatively, a transistor may include a first electrode used as one of the electrodes selected from the source and the drain, a second electrode used as the other one of the electrode selected from the source and the drain, and a gate. In other words, the foregoing pixel circuit includes a MOS transistor by way of example, and may include other suitable transistors as well as the MOS transistor. For example, a pixel circuit may include an active device including a first electrode, a second electrode, and a third electrode, so that the current flowing from the second electrode to the third electrode is controlled by the voltage applied between the first and second electrodes.

In the foregoing embodiments, a light emitting device includes an organic light emitting device, but may include an inorganic light emitting device forming an emission layer.

In the foregoing embodiments, a scan driver and a data driver provided in a display can be directly placed on a glass substrate formed with a pixel portion. Alternatively, a scan driver and a data driver may be substituted by a driving circuit including layers corresponding to a scan line, a data line and a transistor and may be placed on a substrate formed with a pixel portion. Further, a scan driver and/or a data driver may be realized by a chip on a flexible board or a chip on a film (COF). Also, a scan driver and/or a data driver may be realized by a flexible printed circuit (FPC) attached to and electrically connected to a substrate.

As described above, the present invention allows a driving chip for a display to be minimized. Particularly, the present invention allows a driving chip for various sequential driving type displays to be minimized.

Further, a memory of a driver IC provided in a display has a capacity corresponding to one frame, so that the size of a driver IC is decreased, thereby reducing a fabrication cost.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A method of driving a frame memory, the method comprising:
storing video data corresponding to one frame in the frame memory in sequence;
reading out the video data of a first group including one of the video data selected from odd numbered video data and even numbered video data stored in the frame memory at or after a half point of a period for storing the video data corresponding to the one frame;
reading out the video data of a second group including another one of the video data selected from the odd numbered video data and the even numbered video data stored in the frame memory after reading out the video data of the first group; and
transmitting the video data of the first group and the video data of the second group to a transistor to drive at least two light emitting devices in sequence.

2. The method according to claim 1, wherein the storing the video data in sequence comprises storing the video data corresponding to a next frame in sequence at or after a starting point of a period for reading out the video data corresponding to the second group.

3. The method according to claim 1, wherein the storing the video data in sequence comprises storing the video data in sequence with a writing dummy period during which the video data are not stored.

4. The method according to claim 3, wherein the reading out the video data of the first group and the reading out the video data of the second group are in sequence and comprise reading out the video data of the first group and reading out the video data of the second group in sequence with first and second reading dummy periods during which the video data are not read.

5. The method according to claim 4, wherein the writing dummy period is equal to a sum of the first and second reading dummy periods.

6. The method according to claim 1, wherein the reading out the video data of the first group or the reading out the video data of the second group is twice as fast as the storing the video data.

7. The method according to claim 1, wherein the video data of the first group and the video data of the second group include signals corresponding to one color.

8. The method according to claim 1, wherein the frame memory has a capacity to store the video data corresponding to the one frame.

9. A display comprising:
a pixel portion comprising a plurality of pixels electrically connected to a plurality of scan lines, a plurality of emission control lines, and a plurality of data lines, at least one of the pixels comprises a first transistor adapted to drive first and second light emitting devices in sequence;
a driver adapted to supply a scan signal, a emission control signal, and a data signal to at least one of the scan lines, at least one of the emission control lines, and at least one of the data lines, respectively;
a frame memory adapted to store video data; and
a controller adapted to control the driver and the frame memory,
wherein the controller stores the video data corresponding to one frame in the frame memory in sequence, reads out the video data of a first group including one of the video data selected from odd numbered video data and even numbered video data stored in the frame memory at a half point of a period for storing the video data corresponding to the one frame and transmits the read video data of the first group to the driver, and reads out the video data of a second group including another one of the video data selected from the odd numbered video data and the even numbered video data stored in the frame memory after reading out the video data of the first group, and transmits the read video data of the second group to the driver.

10. The display according to claim 9, wherein first video data corresponding to the video data of the first group and second video data corresponding to the video data of the second group are transmitted to a gate of the first transistor to drive the first and second light emitting devices in sequence.

11. The display according to claim 10, wherein the at least one of the pixels comprises
the first and second light emitting devices;
a second transistor adapted to transmit the first and second video data to the gate of the first transistor in sequence in response to the scan signal;
a capacitor adapted to maintain a voltage applied between the gate and a source of the first transistor in response to a first voltage corresponding to the first video data and a second voltage corresponding to the second video data alternately;
the first transistor adapted to supply a current based on the first and second voltages to the first and second light emitting devices in sequence;
a third transistor adapted to limit the current flowing from the first transistor to the first light emitting device in response to a first emission control signal for a first period of the one frame; and
a fourth transistor adapted to limit the current flowing from the first transistor to the second light emitting device in response to a second emission control signal for a second period of the one frame.

12. The display according to claim 9, wherein the controller stores the video data corresponding to a next frame in sequence at or after a starting point of a period for reading out the video data corresponding to the second group.

13. The display according to claim 9, wherein the controller stores the video data in sequence with a writing dummy period during which the video data are not stored.

14. The display according to claim 13, wherein the controller reads out the video data of the first group and the video data of the second group in sequence and with first and second reading dummy periods during which the video data are not read.

15. The display according to claim 14, wherein the writing dummy period is equal to a sum of the first and second reading dummy periods.

16. The display according to claim 9, wherein the controller reads out the video data of the first group or the video data of the second group twice as fast as the controller stores the video data.

17. The display according to claim 9, wherein the frame memory has a capacity adapted to store the video data corresponding to the one frame.

18. The display according to claim 9, wherein the driver comprises a scan driver adapted to supply the scan signal to the pixel portion, and a data driver adapted to supply the data signal to the pixel portion.

19. The display according to claim 9, wherein the at least one of the pixels comprises an organic light emitting diode formed with an organic emission layer, and a pixel circuit adapted to control the organic light emitting device.

20. The display according to claim 9, wherein the controller reads out the video data of the first group and the video data of the second group with first and second reading dummy periods during which the video data are not read.
